(19) United States
(12) Patent Application Publication
(10) Pub. No.: US 2007/0240577 A1
(43) Pub. Date: Oct. 18, 2007

(54) SYSTEM FOR CLEANING A CYLINDRICAL FILTER

(76) Inventor: SCOT H. WEISS, Orlando, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/737,137

(22) Filed: Apr. 18, 2007

Related U.S. Application Data
(60) Provisional application No. 60/792,900, filed on Apr. 18, 2006.

(51) Int. Cl. B01D 46/04

(52) U.S. Cl. 96/230

(57) ABSTRACT

A system configured to clean a cylindrical filter having at least an opening therethrough the longitudinal center of the filter, the system including a canister, a fixation rod located within the canister that rotates about an longitudinal axis, a gearbox system connected to the fixation rod configured to rotate the fixation rod, a lid configured to cover a top opening of canister, and a means configured for continuous manual interaction to operate the gearbox system to result in rotation fixation rod at a high rate of rotation.

### FIELD OF INVENTION

The present invention relates to cleaning filters, and more specifically to a hand operated apparatus for cleaning cylindrical filters with an opening therethrough the center.

### BACKGROUND OF THE INVENTION

Cylindrical filters, or cartridges, with openings through a longitudinal center are used in a plurality of devices. For example, vacuum devices designed to suction both wet and dry materials utilize such filters. After continued use dry particles and other debris attaches to the filter obstructing the passage of air therethrough the filter.

Cylindrical filters are also used in swimming pool filtering systems, spa cleaning systems, and as air filters for motorized engines. For example, many swimming pools utilize a pump that re-circulates water through pleated paper filter cartridges. These cartridges typically have a parallel array of cylindrical filters with two open ends.

The cylindrical filters are periodically removed from the filter housing so as to be manually cleaned and inspected. A typical cleaning of a filter includes immersing the filter within a chlorine-containing solution and spraying the filter with a garden hose. As should be obvious, such an approach may require a large area, usually an outside area due to the cleaning substance being used. As discussed above, these filters also have wet particles, dry particles, and other debris that attach to the filter during operation within the system that cartridges are being used to filter.

Once any of these filters are used for a given period and due to the material that accumulates either on and/or in the filter, one approach to improving the performance of the system in which the filter used is to replace it with a new filter. However, this results in a recurring financial commitment to insure an effective operating device, or device. As disclosed above, another approach has been to clean the filter. Though cleaning systems and/or methods have been described as quick, easy, and efficient, such systems and/or methods usually still required a recurring financial commitment, specifically power cost to operate the system and/or method, as well as an inordinate amount of area to perform the cleaning process.

Owners of systems and/or methods that require a cylindrical filter having a hole formed therethrough a center axis or partially formed therethrough would benefit from a system and/or method that provides a further financial savings by not requiring a power source that requires a direct cost, such as but not limited to gas and/or electricity.

### BRIEF DESCRIPTION OF THE INVENTION

Exemplary embodiments of the invention disclose a system and method for drying an article of clothing manually. An embodiment is directed towards a filter cleaning system and method for cleaning a filter using centrifugal forces. More specifically, a system configured to clean a cylindrical filter having at least an opening therethrough the longitudinal center of the filter is disclosed. The system includes a canister, and a fixation rod located within the canister that rotates about a longitudinal axis. A gearbox system is connected to the fixation rod configured to rotate the fixation rod. A lid is configured to cover a top opening of canister. A means, such as but not limited to a lever, crank, button, etc., is configured for continuous manual interaction to operate the gearbox system to result in rotation fixation rod at a high rate of rotation.

In another exemplary embodiment, a method for cleaning a cylindrical filter having at least an opening therethrough the longitudinal center of the filter is disclosed. The method includes a step for fixing the filter on a rod that rotates about a longitudinal axis upon at least one of a base end and a top end of the rod. Another step involves continuously manually actuating the rotation of the rod and filter about the longitudinal axis at a rate that exceeds a rate of actuating.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 depicts an embodiment of a filter cleaning system;

FIG. 2 depicts a side view of an embodiment an inside of a filter cleaning system;

FIG. 3 depicts an embodiment of a gearbox system;

FIG. 4 depicts an embodiment of a rod fixation element of the cleaning system;

FIG. 5 depicts another embodiment of the filter cleaning system; and

FIG. 6 depicts a flow chart illustrating steps for cleaning a cylindrical filter.

### DETAILED DESCRIPTION OF THE INVENTION

Reference will now be made in detail to the embodiments consistent with the invention, examples of which are illustrated in the accompanying drawings. The present invention solves problems in the art by providing an apparatus that allows for cleaning a swimming pool filter manually within an enclosed area.

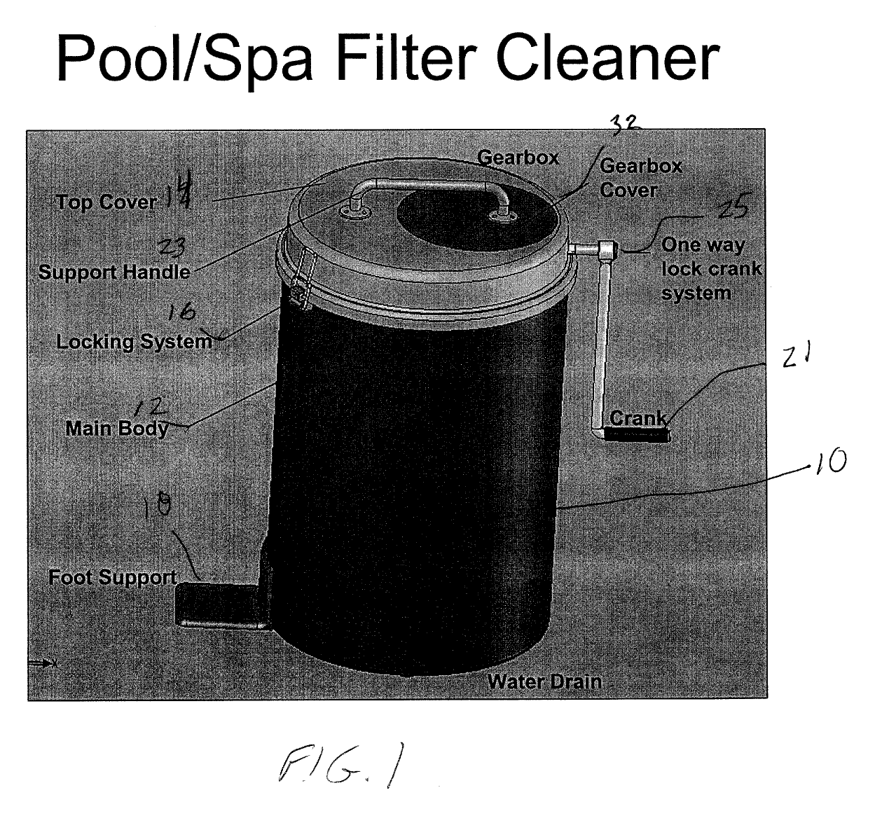

FIG. 1 depicts an embodiment of a filter cleaning system. A container 10 is provided into which a filter 20 is placed. The container 20 has a main body 12 and a top cover 14. The top cover 14 is removable from the main body 12. A locking device 16 is provided, such as but not limited to latches, to secure the top cover 14 to the main body 12. The container 10 has a first support device 18 upon which a force may be applied to insure that the container does not moves when a lever and/or crank 21 is manually operated. As illustrated the support device 18 is a foot support, upon which a user may place a foot. A second support device 23 may also be included, such as a handle for the user to place a hand.

As disclosed above, a crank 21 is also illustrated. Though a crank is illustrated other means that involve manual intervention may be used in place of the crank 21, such as but not limited to a button that is continuously pushed and a lever that may be lifted and lowered and/or pushed and pulled. For safety considerations, the crank 21 may be configured to allow turning of the crank in only one direction. Thus a one-way locking device 25 may be connected to the crank 21 to perform this function. However, such a locking device 25 is not required. Rotating the crank 21 causes gears within a gearbox system 30 to rotate. The gearbox system 32 cover is further illustrated.

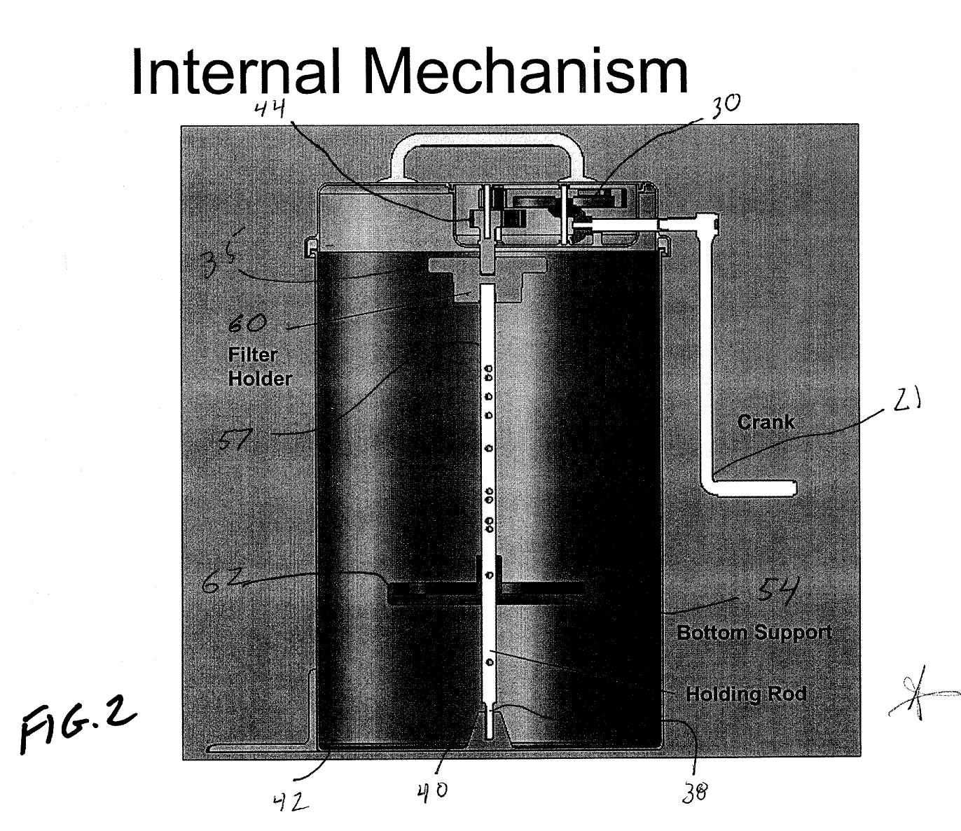

FIG. 2 depicts a side view of an embodiment an inside of a filter cleaning system. Within the container 10 is a rod fixation device 35 that fits within the center opening of the filter 20. The rod fixation device 35 is rotateable, or spins, about its axis and holds the filter 20 in place so that as the rod fixation device 35 rotates the filter 20 also does. The rod fixation device 35 extends longitudinally through the center of the container 10, having an insertion piece 38 that fits within a receiving end 40 located at a base 42 of the container 10.

The top end of the rod fixation device 35 is connected to a rod gear 44 that is part of the gearbox system 30. The rod gear 44 turns as the crank 21 is rotated. Thus, as the hand crank 21 is manually turned, the gears within the gearbox system 30 turn so as to rotate the rod fixation device 35. The gear ratio is at a degree so that the rod fixation device 35 turns at a rate faster than the turning of the hand crank 21.

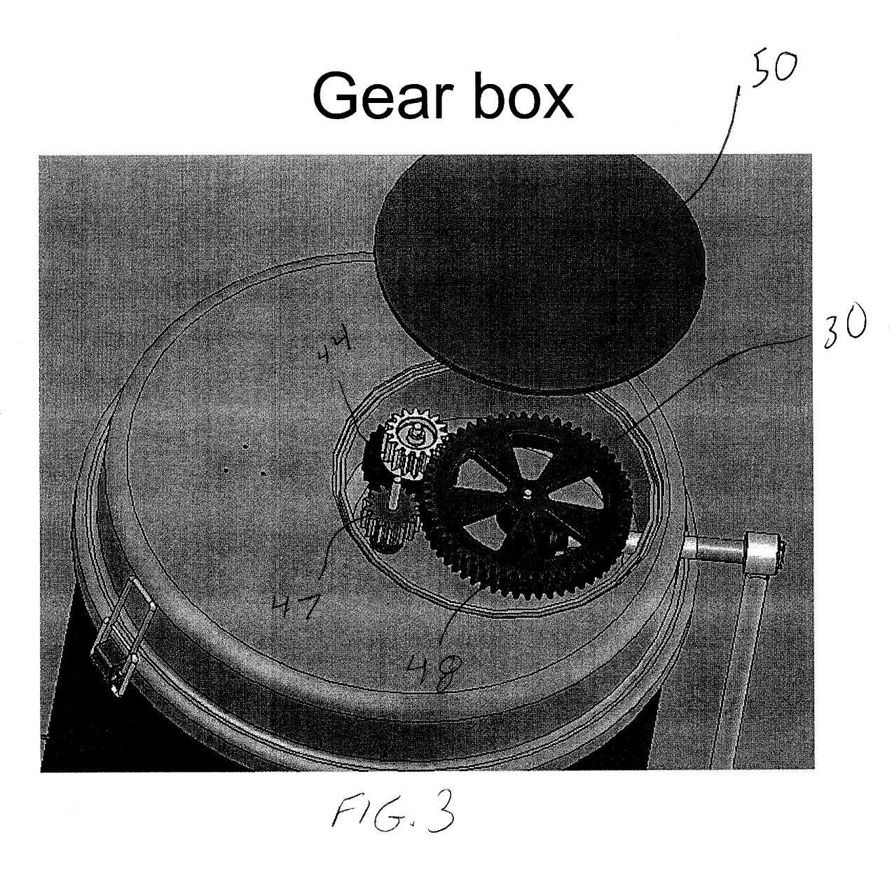

FIG. 3 depicts an embodiment of a gearbox system. As disclosed above, the gearbox system 30 is driven by the crank 21. A plurality of interacting gears 44, 47, 48 are disclosed. Those skilled in the art will recognize that a plurality of gear arrangements may be employed. The crank 21, through the interacting gears 44, 47, 48, rotates the rod fixation device 35, and thus a filter 20 located upon the rod fixation device 35, at a ratio approximately between 5 to 1 to 10 to 1. For example, as disclosed below when cleaning a wet filter such as one used in a pool system, a spin ratio of approximately 6.25 to 1 may be used. Whereas where no cleaning liquid is provided within the container 10, a ratio of approximately 10 to 1 may be used. This high ratio exerts sufficient centrifugal force to repel dirt and debris attached to and/or trap within the filter. As illustrated the gearbox system 30 has a removable lid 50 that may be removed to replace any gears 44, 47, 48 if a need arises.

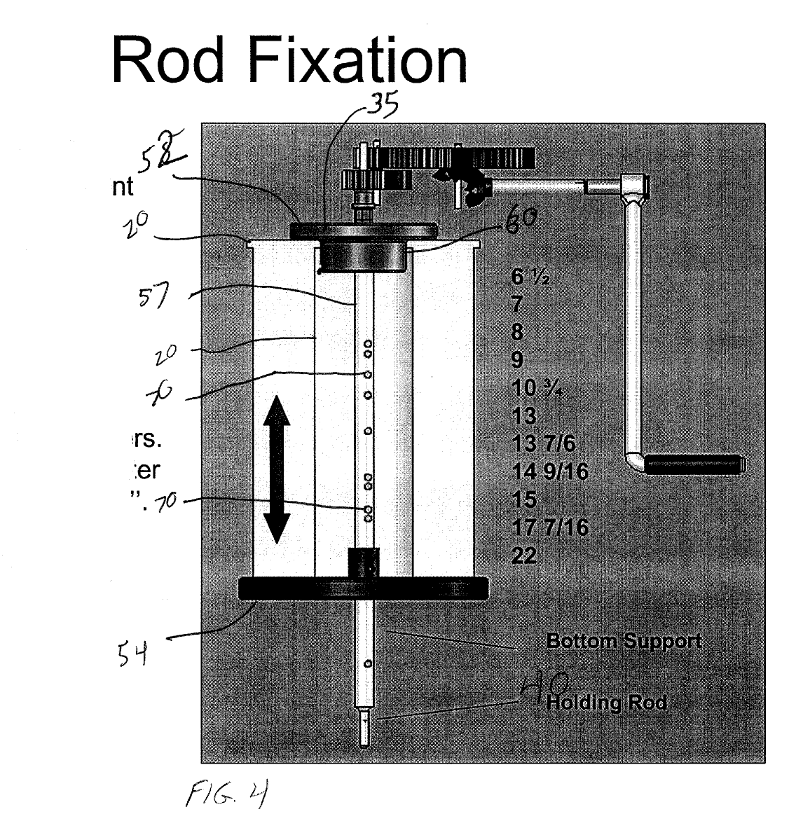

FIG. 4 depicts an embodiment of a rod fixation device of the cleaning system. The rod fixation device 35 has a top end 52 and a bottom end 54, or base end. A center rod 57 extends vertically from the top end 52 down through the bottom end 54. As discussed above, the second end of the rod 57, below the base located at the bottom end 54 has an insertion end 38 that fits within the receiving end 40 located at the base 42 of the container 10. The top end 52 has a holding element 60 that fits within the center opening of the filter 20. Because the diameter of the center opening of a filter may vary filter to filter, either a plurality of holding elements 60 may be provided which are interchangeable, the holding element 60 may have elements that may be extended from it to accommodate larger sizes, or a inverted conical holding element may be used so that the center opening of the filter 20 will engage the holding element 60 at a location on the holding element 60 based on the diameter of the filter opening.

The bottom end 54 is also hold variable filter diameters. In an exemplary embodiment the bottom end 54 may hold diameters up to ten inches. In one embodiment, the bottom end 54 may have a ridge 62 into which the filter 20 fits. Thus, as the filter 20 is turned, it is further maintained in place by this ridge 62. In another embodiment a plurality of ridges 62 may be formed in the bottom end 54 wherein the filter 20 fits within a given ridge 62 based on its diameter.

The center rod 57 may be adjustable so that filters of various heights will reach from the holding element to the bottom element. As illustrated, the height adjusted may range from approximately less than one inch to twenty-two inches. The adjustment may be accomplished with a plurality of performed holes 70 through which a detent may be pushed into the rod 57 and then pops out when its extending end is in line with one such hole 70.

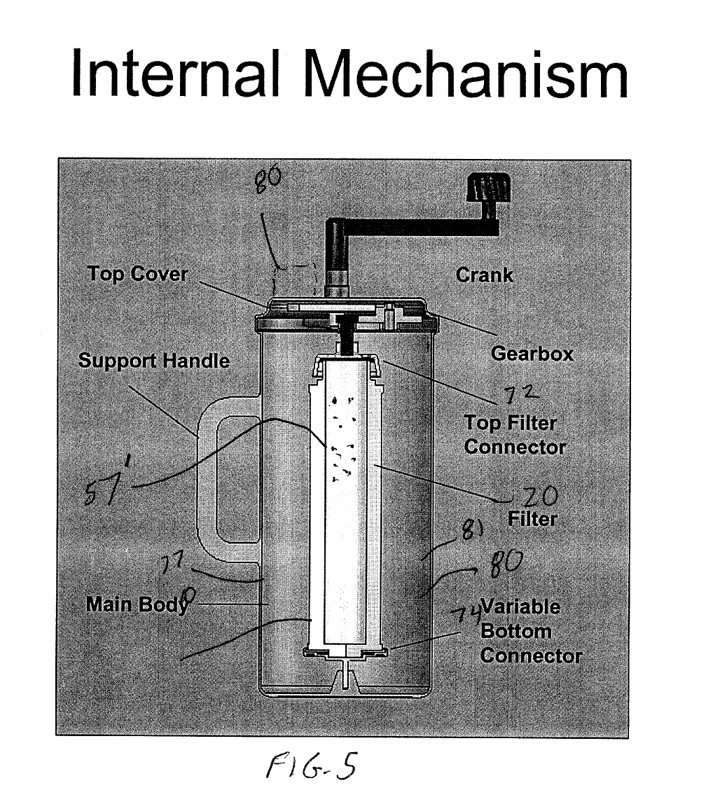

FIG. 5 depicts another embodiment of the filter cleaning system. As illustrated the crank 21 is located on the top of the canister cover 14. The gearbox system 30 is still located within the canister cover 14 area. A support element 23′ is provided for where a hand may be placed. A top filter connector 72 and a bottom filter connector 74 are provided. The top connector 72 latches onto an outer surface of the filter 20. The top connector 72 is able to accommodate a plurality of different diameter filters 20. The bottom filter connector 74 is translatable up and down the vertical center rod 57′ so that various filter heights may be accommodated. Also, the bottom connector 74 is of a size to accommodate a plurality of different sized filter diameters and may include such holding devices as the ridges disclosed above.

In operation, the as the crank 21 is rotated, the gears 44, 47, 48 in turn rotate the rod 57, 57′ about its axis which in turn also rotates the filter 20 fixed to the rod 57, 57′. The centrifugal force created by the rotation of the filter 20 pulls the debris and/or dirt from the filter 20. In one embodiment no liquid is used within the canister 10. As disclosed below, in another embodiment liquid may be used.

The debris and/or dirt may strike the inner wall 77 of the canister 10 and drop to the bottom 42 of the canister 10. In another exemplary embodiment, a removable adhesive insert 80 may be positioned proximate the inner wall 77 of the canister 10 so that dirt and/or debris leaving the filter 20 at a high enough velocity may impinge upon the adhesive surface while other dirt and/or debris, with less velocity, or not having room to attach to the adhesive surface 81 drops to the bottom 42 of the canister 10. Such an adhesive insert may work best when no liquid is provided within the canister.

In another embodiment, a liquid, such as a chlorination solution is placed within the canister. The rotating of the filter 20 within the liquid will loosen and remove dirt and/or debris from the filter 20. In embodiment, an opening may be provided therethrough the longitudinal center of the rod 57, 57′ so that a cleaning fluid is applied through this opening. A plurality of holes may be provided along the length of the rod to allow the liquid to pass from the rod to and then through the filter 20. A reservoir 80 to hold the liquid may be provided. Though a cleaning fluid is disclosed, other liquids may also be utilized such as but not limited to a fragrance, that will impinge upon the filter resulting in a pleasing smell, depending on the use of the filter.

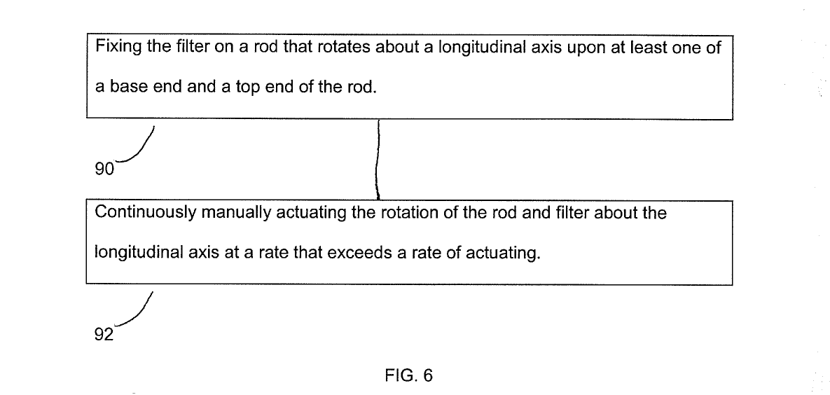

FIG. 6 depicts a flow chart illustrating steps for cleaning a cylindrical filter. One step includes fixing the filter on a rod that rotates about a longitudinal axis upon at least one of a base end and a top end of the rod, step 90. Another step, step 92, involves continuously manually actuating the rotation of the rod and filter about the longitudinal axis at a rate that exceeds a rate of actuating.

While exemplary embodiment of the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method for cleaning a cylindrical filter having at least an opening therethrough the longitudinal center of the filter, the method comprising:
a) fixing the filter on a rod that rotates about a longitudinal axis upon at least one of a base end and a top end of the rod; and
b) continuously manually actuating the rotation of the rod and filter about the longitudinal axis at a rate that exceeds a rate of actuating.

2. The method according to claim 1, further comprises applying a liquid around at least a portion of an outer circumference of the filter while manually actuating the rotation of the rod and the filter.

3. The method according to claim 1, further comprises applying a liquid therethrough the center of the filter while manually actuating the rotation of the rod and filter.

4. The method according to claim 1, further comprises adjusting at least one of the base end of the rod and the top end of the rod to hold a plurality of elongated filters.

5. The method according to claim 1, further comprises adjusting at least one of the base end of the rod and the top end of the rod to hold a plurality filters with varying diameters of the opening at least partially therethrough the longitudinal center of the filters.

6. A system configured to clean a cylindrical filter having at least an opening therethrough the longitudinal center of the filter, the system comprising:
a) a canister;
b) a fixation rod located within the canister that rotates about an longitudinal axis;
d. a gearbox system connected to the fixation rod configured to rotate the fixation rod;
e. a lid configured to cover a top opening of canister; and
f. a means configured for continuous manual interaction to operate the gearbox system to result in rotation fixation rod at a high rate of rotation.

7. The system according to claim 6 wherein the high rate of rotation exceeds a rate that the means configured for continuous manual interaction produces.
